(19) United States
(12) Patent Application Publication
(10) Pub. No.: US 2017/0047867 A1
(43) Pub. Date: Feb. 16, 2017

(54) ELECTROSTATIC CHUCK WITH ELECTROSTATIC FLUID SEAL FOR CONTAINING BACKSIDE GAS

(71) Applicant: Applied Materials, Inc., Santa Clara, CA (US)

(72) Inventors: ZUOQIAN WANG, Dublin, CA (US); John M. White, Hayward, CA (US)

(21) Appl. No.: 14/824,170

(22) Filed: Aug. 12, 2015

(51) Int. Cl. H02N 13/00

(52) U.S. Cl. CPC H02N 13/00

(57) ABSTRACT

In one embodiment, an electrostatic chuck is provided and includes a backing substrate, and a puck substrate disposed on the backing substrate, the puck substrate comprising a plurality of central chucking modules surrounded by a perimeter chucking module, the perimeter chucking module having a first electrode and a second electrode that are parallel to each other and substantially parallel to sides of the puck substrate.

### BACKGROUND

Field

Embodiments of the present disclosure generally relate to an electrostatic chuck with a baskside gas transfer means for controlling temperature of a substrate chucked thereon.

Description of the Related Art

Plasma display panels, organic light emitting diode (OLED) displays and liquid crystal displays (LCDs) are frequently used for flat panel displays. LCDs generally contain two glass substrates joined together with a layer of a liquid crystal material sandwiched therebetween. The glass substrate may be a semiconductor substrate, or may be a transparent substrate such as a glass, quartz, sapphire, or a clear plastic film. The LCD may also contain light emitting diodes for back lighting. Further, OLED displays have attracted attention for applications such as smart phones and tablets, among other devices. OLED's are a special type of light-emitting diodes in which a light-emissive layer comprises a plurality of thin films of certain organic compounds. OLED's can also be used for general space illumination. The range of colors, brightness, and viewing angle possible with OLED displays are greater than those of traditional displays because OLED pixels emit light directly and do not require a back light. Therefore, the energy consumption of OLED displays is considerably less than that of traditional displays. Further, the fact that OLED's can be manufactured onto flexible substrates opens the door to new applications such as roll-up displays or even displays embedded in flexible media.

In conventional deposition processes, the organic material is evaporated onto a substrate in a vertical orientation. The substrates are typically held in the vertical orientation using mechanical clamping force. Conventional mechanical clamping carriers used to hold a substrate during transfer and sometimes processing may often result in substrate damage due to the high mechanical clamping force needed to restrain the substrate. In addition, the conventional mechanical clamping carriers generally hold the substrate at the edges, thus resulting in a highly concentrated physical contact with the edges of the substrate so as to ensure sufficient clamping force applied to securely fix the substrate. This mechanical contact concentrated at the edges of the substrate inevitably creates contact contamination or physical damage, undesirably polluting the substrate. In a vertical processing system, temperature control of the substrate during processing has become challenging. Poor temperature control of the substrate may result in material deposition failure, which inevitably leads to inconsistent or undesirable electrical properties of the substrate. Cooling gases provided to the backside of the substrate can be used to effectively control temperature of the substrate.

Thus, there is a need for a substrate carrier having an electrostatic chucking capability with a seal that provides containment of backside gases.

### SUMMARY

Embodiments of the present disclosure generally relate to an electrostatic chuck with a baskside gas transfer means for controlling temperature of a substrate chucked thereon.

In one embodiment, an electrostatic chuck is provided and includes a backing substrate, and a puck substrate disposed on the backing substrate, the puck substrate comprising a plurality of central chucking modules surrounded by a perimeter chucking module, the perimeter chucking module having a first electrode and a second electrode that are parallel to each other and substantially parallel to sides of the puck substrate.

In another embodiment, a substrate carrier is provided and includes an electrostatic chuck having a backing substrate made of a metallic material, and a puck substrate that is disposed on the backing substrate, the puck substrate comprising a plurality of central chucking modules surrounded by a perimeter chucking module, the perimeter chucking module having a first electrode and a second electrode that are parallel to each other and substantially parallel to sides of the puck substrate.

In another embodiment, a method for chucking a display substrate is provided and includes providing an electrostatic chuck having a puck substrate with a chucking surface, placing the display substrate onto the chucking surface, and forming an electrostatic fluid seal at a perimeter of the display substrate by biasing a first electrode and a second electrode that are parallel to each other and substantially parallel to sides of the puck substrate.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is an elevation view of one embodiment of an electrostatic chuck.

FIG. 2 is a cross-sectional view of the electrostatic chuck along lines 2-2 of FIG. 1.

FIG. 3 is an elevation view of another embodiment of an electrostatic chuck.

FIG. 4 is a cross-sectional view of the electrostatic chuck along lines 4-4 of FIG. 3.

FIG. 5 is a cross-sectional view of another embodiment of an electrostatic chuck.

FIG. 6 is a partial cross-sectional view of another embodiment of an electrostatic chuck.

FIG. 7 is a schematic plan view of a manufacturing system according to one embodiment, utilizing electrostatic chucks as described herein.

FIG. 8 is a top cross-sectional view of one embodiment of a deposition chamber.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to an electrostatic chuck with a baskside gas transfer means for controlling temperature of a substrate chucked thereon. In some embodiments, the electrostatic chuck may be utilized as a substrate carrier suitable for maintaining a substrate in a vertical orientation during processing and methods for using the same.

The embodiments disclosed herein may be practiced utilizing a vertical deposition system, for example a vertical CVD or vertical PVD chamber, such as a modified AKT New Aristo™ Twin PVD system available from Applied Materials, Inc., Santa Clara, Calif. It is to be understood that the embodiments of the disclosure may be practiced in other processing systems as well, including non-inline systems (i.e., cluster tools) as well as systems sold by other manufacturers. It should also be noted that although the electrostatic chuck described herein is particularly beneficial for use in vertical processing systems, the electrostatic chuck is equally adapted for processing systems that retain a substrate in a non-vertical orientation, such as a horizontal orientation.

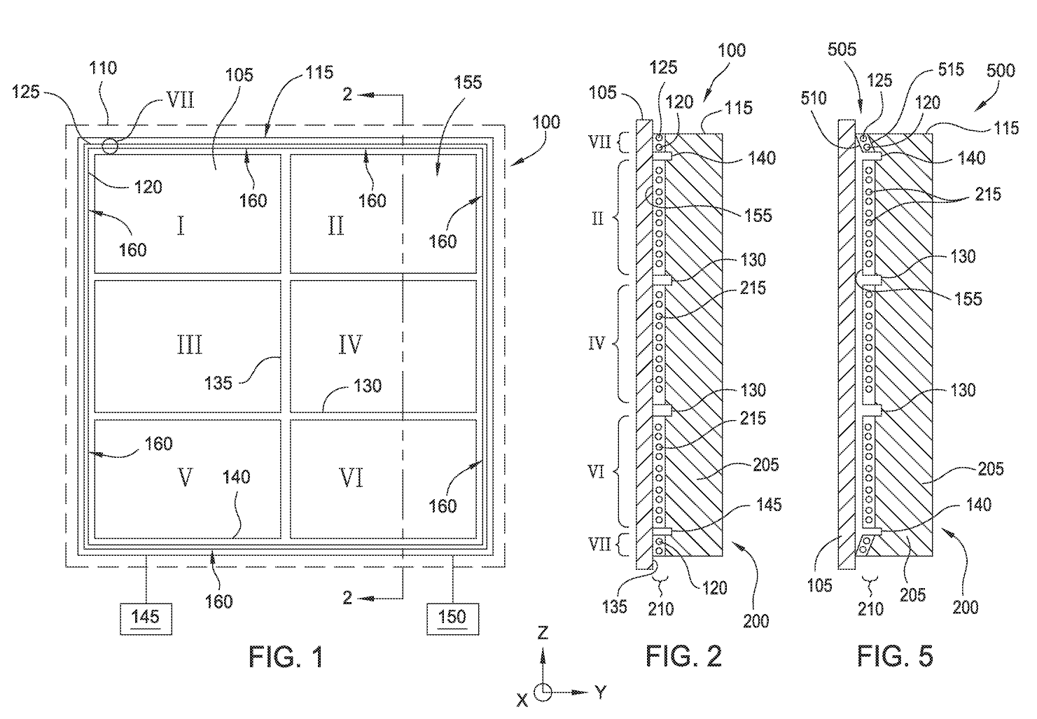

FIG. 1 is an elevation view of one embodiment of an electrostatic chuck 100. The electrostatic chuck 100 is a bipolar electrostatic chuck, in this embodiment. The electrostatic chuck 100 has a substrate 105 supported thereon (shown in dashed lines). The substrate 105 may be made from any material suitable for a material deposition process. For example, the substrate 105 may be made from a material selected from the group consisting of glass (for instance soda-lime glass, borosilicate glass, etc.), metal, polymer, ceramic, compound materials, carbon fiber materials or any other material or combination of materials which can be coated by a deposition or evaporation process. The substrate 105 may be flexible or rigid.

A peripheral edge 110 of the substrate 105 may extend slightly over a perimeter 115 of the electrostatic chuck 100. The electrostatic chuck 100 may comprise one or more central chucking modules I-VI as well as a perimeter chucking module VII. The perimeter chucking module VII comprises at least a first electrode 120 and a second electrode 125. Both of the first electrode 120 and the second electrode 125 are positioned slightly inward of the perimeter 115 of the electrostatic chuck 100. Both of the first electrode 120 and the second electrode 125 are oriented in a plane generally parallel to the perimeter 115 of the electrostatic chuck 100 (i.e., each side). Both of the first electrode 120 and the second electrode 125 may be substantially parallel to each other.

The electrostatic chuck 100 also includes backside gas grooves, such as interior gas grooves 130 and 135, and a perimeter gas groove 140. The grooves 130, 135 and 140 may be coupled to a cooling/heating reservoir 145 that provides a temperature control fluid to a backside BS of the substrate 105 (shown in FIG. 2). The temperature control fluid may be a cooling or heating fluid (e.g., temperature regulating medium) adapted to remove heat or provide heat to the substrate 105. The temperature control fluid may be argon, nitrogen, helium, or other suitable gas or gases.

The electrostatic chuck 100 may also be coupled to a voltage supply 150, such a direct current (DC) power supply, that provides electrical power to the first electrode 120, the second electrode 125 and electrodes in the central chucking modules I-VI (not shown in FIG. 1). The voltage supply 150 may be used to provide a bias voltage to discrete electrodes (e.g., alternating positive (+) and negative (−) biased electrodes) in each of the central chucking modules I-VI. The bias voltage may be applied to the central chucking modules I-VI in a specific sequence or simultaneously. For example, the substrate 105 may be chucked sequentially from side to side by actuating the central chucking modules I, II and V first, and then actuating the central chucking modules II, IV and VI. In this manner, any air present between the substrate 105 and a chucking surface 155 of the electrostatic chuck 100 may be purged. In another example, the substrate 105 may be chucked from a center to the edge by actuating the central chucking modules III and IV first, and then actuating the central chucking modules I-II and V-VI.

In both of the bias application examples, the perimeter chucking module VII may be actuated in order to electrostatically attract the peripheral edge 110 of the substrate 105 against the chucking surface 155 at the perimeter 115 of the electrostatic chuck 100. In this manner, an electrostatic fluid seal 160 is provided by the electrical forces of the first electrode 120 and the second electrode 125 which urges the backside BS of the substrate 105 against the chucking surface 155.

FIG. 2 is a cross-sectional view of the electrostatic chuck 100 along lines 2-2 of FIG. 1. The electrostatic chuck 100 comprises a body 200 that includes a backing substrate 205 and a puck substrate 210. The backing substrate 205 may be made of a metallic material such as aluminum. The puck substrate 210 may be made of a material having good thermal stability, chemical resistance, and utilization in temperatures up to about 450 degrees Celsius. The puck substrate 210 may be a polymer material, such as a polymer of imide monomers, for example, polyimide. The surface of the puck substrate 210 opposing the surface thereof coupled to the backing substrate 205 forms the chucking surface 155 of the electrostatic chuck 100. Both of the first electrode 120 and the second electrode 125, as well as electrodes 215 of the central chucking modules I-VI are embedded in the puck substrate 210. The grooves 130, 135 (shown in FIG. 1) and 140 may be formed at least partially in the backing substrate 205. The electrodes 215 are alternating positive (+) and negative (−) biased electrodes of the central chucking modules I-VI are coupled to the voltage supply 150 (shown in FIG. 1).

In some embodiments, the chucking surface 155 of the central chucking modules I-VI are disposed in a plane (X-Z plane) and the chucking surface 155 of the perimeter chucking module VII is coplanar to the X-Z plane. In other embodiments, the chucking surface 155 of the perimeter chucking module VII is parallel to the chucking surface 155 of the central chucking modules I-VI. In one example, the chucking surface 155 of the perimeter chucking module VII may be raised slightly as compared to the plane of the chucking surface 155 of the central chucking modules I-VI.

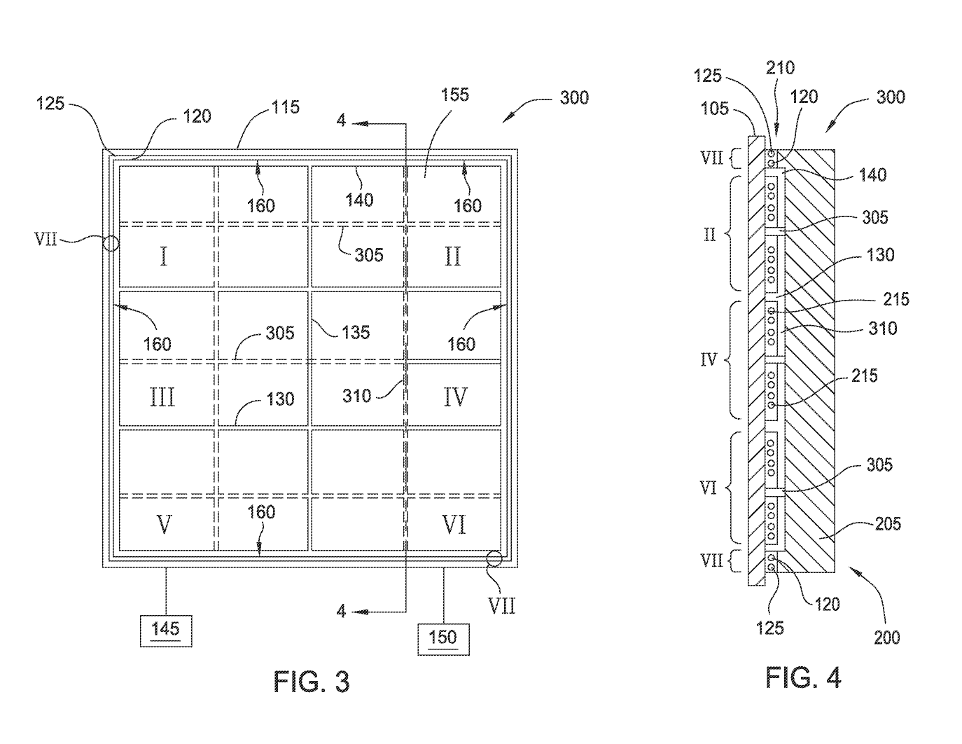

FIG. 3 is an elevation view of another embodiment of an electrostatic chuck 300 and FIG. 4 is a cross-sectional view of the electrostatic chuck 300 along lines 4-4 of FIG. 3. The electrostatic chuck 300 includes a chucking surface 155 for receiving a substrate (not shown in FIG. 3). The electrostatic chuck 300 according to this embodiment has one or more central chucking modules I-VI as well as the perimeter chucking module VII. The electrostatic chuck 300 is substantially the same as the electrostatic chuck 100 with the following exceptions. One or more additional grooves or channels are formed under the central chucking modules I-VI. Channels 305 and 310, shown in dashed lines in FIG. 3, intersect with the grooves 130, 135 and 140. The channels 305 may be substantially parallel (e.g., +1- about 3 degrees) to the grooves 130 and the channels 310 may be substantially parallel to the grooves 135. The channels 305 and 310 may be substantially parallel to the sides of the electrostatic chuck 100 (e.g., the perimeter 115 of the electrostatic chuck 100).

FIG. 5 is a cross-sectional view of another embodiment of an electrostatic chuck 500. The electrostatic chuck 500 is substantially the same as the electrostatic chuck 100 with the following exceptions. The electrostatic chuck 500 includes a chucking surface 155 for receiving a substrate (not shown in FIG. 5). However, a perimeter of the puck substrate 210 includes a tapered region 505. The tapered region 505 having the electrodes 120 and 125 disposed therein may be an angled surface 510 of the puck substrate 210 that tapers inwardly from the perimeter 115 of the electrostatic chuck 100 toward the backing substrate 205. The tapered region 505 may be formed by a taper 515 that is provided on the backing substrate 205. Alternatively, the tapered region 505 may be a region of the puck substrate 210 where thickness is varied to provide the angled surface 510. While not shown, the tapered region 505 may comprise a curved surface in some embodiments.

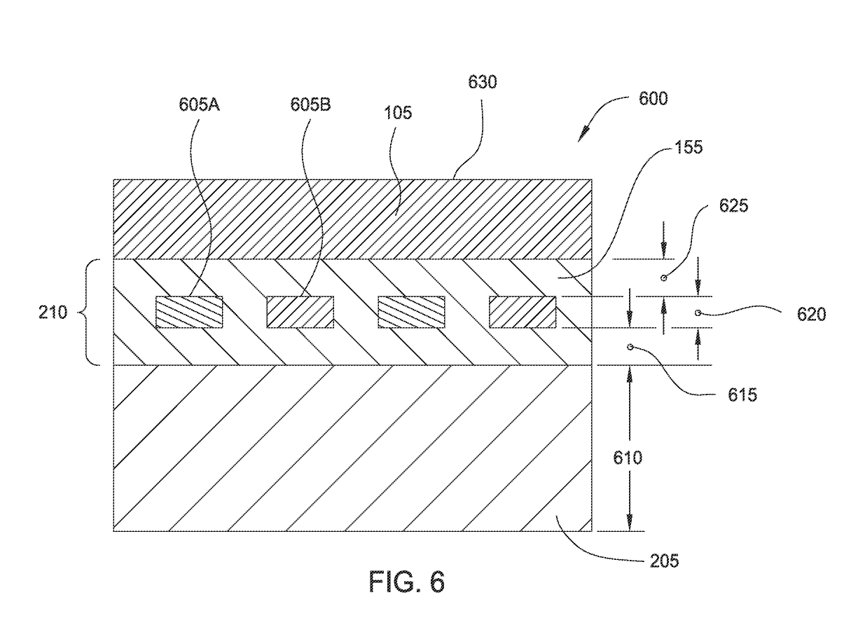

FIG. 6 is a partial cross-sectional view of another embodiment of an electrostatic chuck 600. The electrostatic chuck 600 includes the backing substrate 205 and the puck substrate 210. The puck substrate 210 includes a plurality of first electrodes 605A and a plurality of second electrodes 605B. Each of the first electrodes 605A alternate with second electrodes 605B. The first electrodes 605A may be biased positively and the second electrodes 605B may be biased negatively, or vice versa. When energized, a substrate 105 may be attracted to a chucking surface 155 of the puck substrate 210.

The backing substrate 205 may include a thickness 610 of about 5 millimeters (mm) to about 30 mm. The puck substrate 210 may include a thickness 615 below the electrodes 605A, 605B of about 10 microns (μm) to about 500 μm. A thickness 620 of the first electrodes 605A and the second electrodes 605B may be about 5 μm to about 50 μm. The puck substrate 210 may also include a thickness 625 above the electrodes 605A, 605B of about 10 μm to about 500 μm.

The electrostatic chucks 100, 500 and 600 as described herein may be used for organic light emitting diode (OLED) manufacture wherein organic materials are evaporated, and metals and/or dielectric materials may be deposited onto the substrate 105. In some embodiments, portions of OLED devices may be deposited by a plasma process, such as chemical vapor deposition (CVD) or physical vapor deposition (PVD). In conventional plasma processing applications, the temperature within the chamber may be controlled at different ranges. In some applications, the temperature in a plasma process is typically below 250 degrees Celsius. A shadow mask (not shown) may be coupled to a deposition surface 630 of the substrate 105 (shown in FIG. 6). The shadow mask may be a metallic mask having patterns of fine openings formed therein that controls where deposited materials may impinge the substrate 105. During plasma processing of the substrate 105 in a vertical orientation, it is often difficult to control the mask position on the substrate 105 due to expansion and contraction of the metal mask. While the metal mask may be formed from a material having a very low coefficient of thermal expansion (CTE), a 1.0 degree Celsius change in temperature may change the position of the metal mask. This expansion or repositioning of the mask cannot be accommodated, especially for high resolution displays (e.g., 500 pixels per inch (ppi) to about 800 ppi).

The metal mask is typically in thermal contact with the deposition surface 630 of the substrate 105 and heat is conducted therebetween. The cooling/heating reservoir 145 coupled to the electrostatic chuck 100 may be used to remove any excess heat which stabilizes the temperature of the substrate 105 as well as the mask.

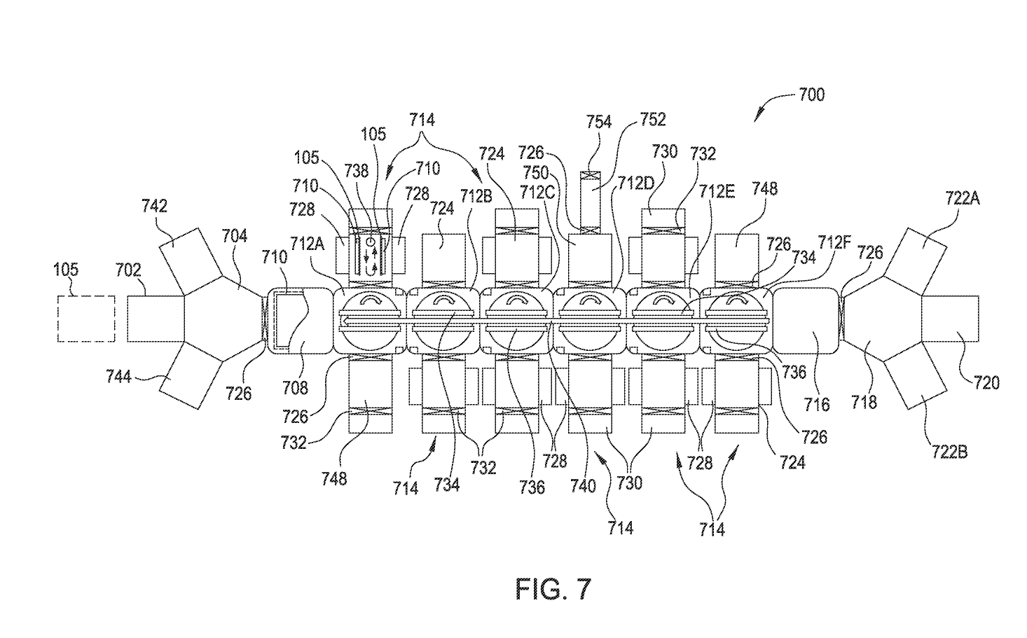

FIG. 7 is a schematic plan view of a manufacturing system 700 according to one embodiment. The system 700 may be used for manufacturing electronic devices, particularly electronic devices including organic materials therein, such as OLED devices. For example, the devices can be electronic devices or semiconductor devices, such as optoelectronic devices and, in particular, displays.

Embodiments described herein particularly relate to deposition of materials, for example, for display manufacturing on large area substrates. The substrates in the manufacturing system 700 may be moved throughout the manufacturing system 700 on carriers that may support one or more substrates by electrostatic chucks 100, 500 and 600 as described herein. According to some embodiments, large area substrates or carriers supporting one or more substrates, for example large area carriers, may have a size of at least 0.174 meters squared (m²). Typically, the size of the carrier can be about 1.4 m² to about 8 m², more typically about 2 m² to about 9 m² or even up to 12 m². Typically, the rectangular area, in which the substrates are supported and for which the electrostatic chucks 100, 500 and 600 as described herein are provided, are carriers having sizes for large area substrates as described herein. For instance, a large area carrier, which would correspond to an area of a single large area substrate, can be GEN 5, which corresponds to about 1.4 m² substrates (1.1 m×1.3 m), GEN 7.5, which corresponds to about 4.29 m² substrates (1.95 m×2.2 m), GEN 8.5, which corresponds to about 5.7 m² substrates (2.2 m×2.5 m), or even GEN 10, which corresponds to about 8.7 ² substrates (2.85 m×3.05 m). Even larger generations such as GEN 11 and GEN 12 and corresponding substrate areas can similarly be implemented. According to typical embodiments, which can be combined with other embodiments described herein, the substrate thickness can be from 0.1 to 1.8 mm and the electrostatic chucks 100, 500 and 600 can be adapted for such substrate thicknesses. However, particularly the substrate thickness can be about 0.9 mm or below, such as 0.5 mm or 0.3 mm, and the electrostatic chucks 100, 500 and 600 are adapted for such substrate thicknesses. Typically, the substrate may be made from any material suitable for material deposition. For instance, the substrate may be made from a material selected from the group consisting of glass (for instance soda-lime glass, borosilicate glass etc.), metal, polymer, ceramic, compound materials, carbon fiber materials or any other material or combination of materials which can be coated by a deposition process.

The manufacturing system 700 shown in FIG. 7 includes a load lock chamber 702, which is connected to a horizontal substrate handling chamber 704. A substrate 105 (outlined in dashed lines), such as a large area substrate as described above, can be transferred from the substrate handling chamber 704 to a vacuum swing module 708.

The vacuum swing module 708 loads the substrate 105 in a horizontal position on a carrier 710. The carrier 710 includes an electrostatic chuck such as the electrostatic chucks 100, 500 and 600 as described herein. After loading the substrate 105 on the carrier 710 in the horizontal position, the vacuum swing module 708 rotates the carrier 710 having the substrate 105 provided thereon in a vertical or substantially vertical orientation. The carrier 710 having the substrate 105 provided thereon is then transferred through a first transfer chamber 712A and at least one subsequent transfer chamber (712B 712F) in the vertical orientation. One or more deposition apparatuses 714 can be connected to the transfer chambers. Further, other substrate processing chambers or other vacuum chambers can be connected to one or more of the transfer chambers. After processing of the substrate 105, the carrier having a substrate 105 thereon is transferred from the transfer chamber 712F into an exit vacuum swing module 716 in the vertical orientation. The exit vacuum swing module 716 rotates the carrier having a substrate 105 thereon from the vertical orientation to a horizontal orientation. Thereafter, the substrate 105 can be unloaded into an exit horizontal glass handling chamber 718. The processed substrate 105 may be unloaded from the manufacturing system 700 through load lock chamber 720, for example, after the manufactured device is encapsulated in one of a thin-film encapsulation chamber 722A or 722B.

In FIG. 7, a first transfer chamber 712A, a second transfer chamber 712B, a third transfer chamber 712C, a fourth transfer chamber 712D, a fifth transfer chamber 712E, and a sixth transfer chamber 712F are provided. According to embodiments described herein, at least two transfer chambers are included in a manufacturing system, and typically 2 to 8 transfer chambers can be included in the manufacturing system. Several deposition apparatuses, for example 9 deposition apparatuses 714 in FIG. 7, each having a deposition chamber 724 and each being exemplarily connected to one of the transfer chambers are provided. According to some embodiments, one or more of the deposition chambers of the deposition apparatuses are connected to the transfer chambers via gate valves 726.

At least a portion of the deposition chambers 724 include a patterned mask (not shown). Each of the deposition chambers 724 also include a deposition source 738 (only one is shown) to deposit film layers on at least one substrate 105. In some embodiments, the deposition source 738 comprises an evaporation module and a crucible. In further embodiments, the deposition source 738 may be movable in the direction indicated by arrows in order to deposit a film on two substrates 105 supported on a respective carrier 710. Deposition is performed on the substrates 105 as the substrates 105 are in a vertical orientation or a substantially vertical orientation with a respective patterned mask between the deposition source 738 and each substrate 105.

Alignment units 728 can be provided at the deposition chambers 724 for aligning substrates relative to the respective patterned mask. According to yet further embodiments, vacuum maintenance chambers 730 can be connected to the deposition chambers 724, for example via gate valve 732. The vacuum maintenance chambers 730 allow for maintenance of deposition sources in the manufacturing system 700.

As shown in FIG. 7 the one or more transfer chambers 712A-712F are provided along a line for providing an in-line transportation system. According to some embodiments, a dual track transportation system is provided. The dual track transportation system includes a first track 734 and a second track 736 in each of the transfer chambers 712A-712F. The dual track transportation system may be utilized to transfer carriers 710 supporting substrates, along at least one of the first track 734 and the second track 736.

According to yet further embodiments, one or more of the transfer chambers 712A-712F are provided as a vacuum rotation module. The first track 734 and the second track 736 can be rotated at least 90 degrees, for example 90 degrees, 180 degrees or 360 degrees. The carriers, such as the carrier 710, move linearly on the tracks 734 and 736. The carriers may be rotated in a position to be transferred into one of the deposition chambers 724 of the deposition apparatus 714, or one of the other vacuum chambers described below, The transfer chambers 712A-712F are configured to rotate the vertically oriented carriers and/or substrates, wherein, for example, the tracks in the transfer chambers are rotated around a vertical rotation axis. This is indicated by the arrows in the transfer chambers 712A-712F of FIG. 7.

According to some embodiments, the transfer chambers are vacuum rotation modules for rotation of a substrate under a pressure below 10 milli bar. According to yet further embodiments, another track is provided within the two or more transfer chambers (712A-712F), wherein a carrier return track 740 is provided. According to typical embodiments, the carrier return track 740 can be provided between the first track 734 and second track 736. The carrier return track 740 allows for returning empty carriers from the further the exit vacuum swing module 716 to the vacuum swing module 708 under vacuum conditions. Returning the carriers under vacuum conditions and, optionally under controlled inert atmosphere (e.g. Ar, N² or combinations thereof) reduces the carriers' exposure to ambient air. Contact with moisture can therefore be reduced or avoided. Thus, the outgassing of the carriers during manufacturing of the devices in the manufacturing system 700 can be reduced. This may improve the quality of the manufactured devices and/or the carriers can be in operation without being cleaned for an extended time period.

FIG. 7 further shows a first pretreatment chamber 742 and a second pretreatment chamber 744. A robot (not shown) or another suitable substrate handling system can be provided in the substrate handling chamber 704. The robot or other substrate handling system can load the substrate 105 from the load lock chamber 702 in the substrate handling chamber 704 and transfer the substrate 105 into one or more of the pretreatment chambers (742, 744). For example, the pretreatment chambers can include a pretreatment tool selected from the group consisting of: plasma pretreatment of the substrate, cleaning of the substrate, UV and/or ozone treatment of the substrate, ion source treatment of the substrate, RF or microwave plasma treatment of the substrate, and combinations thereof. After pretreatment of the substrates, the robot or other handling system transfers the substrate out of pretreatment chamber via the substrate handling chamber 704 into the vacuum swing module 708. In order to allow for venting the load lock chamber 702 for loading of the substrates and/or for handling of the substrate in the substrate handling chamber 704 under atmospheric conditions, a gate valve 726 is provided between the substrate handling chamber 704 and the vacuum swing module 708. Accordingly, the substrate handling chamber 704, and if desired, one or more of the load lock chamber 702, the first pretreatment chamber 742 and the second pretreatment chamber 744, can be evacuated before the gate valve 726 is opened and the substrate is transferred into the vacuum swing module 708. Accordingly, loading, treatment and processing of substrates may be conducted under atmospheric conditions before the substrate is loaded into the vacuum swing module 708.

According to embodiments described herein, loading, treatment and processing of substrates, which may be conducted before the substrate is loaded into the vacuum swing module 708, is conducted while the substrate is horizontally oriented or essentially horizontally oriented. The manufacturing system 700 as shown in FIG. 7, and according to yet further embodiments described herein, combines a substrate handling in a horizontal orientation, a rotation of the substrate in a vertical orientation, material deposition onto the substrate in the vertical orientation, a rotation of the substrate in a horizontal orientation after the material deposition, and an unloading of the substrate in a horizontal orientation.

The manufacturing system 700 shown in FIG. 7 include at least one thin-film encapsulation chamber. FIG. 7 shows a first thin-film encapsulation chamber 722A and a second thin-film encapsulation chamber 722B. The one or more thin-film encapsulation chambers include an encapsulation apparatus, wherein the deposited and/or processed layers, particularly an OLED material, are encapsulated between, i.e. sandwiched between, the processed substrate and another substrate in order to protect the deposited and/or processed material from being exposed to ambient air and/or atmospheric conditions. Typically, the thin-film encapsulation can be provided by sandwiching the material between two substrates, for example glass substrates. However, other encapsulation methods like lamination with glass, polymer or metal sheets, or laser fusing of a cover glass may alternatively be applied by an encapsulation apparatus provided in one of the thin-film encapsulation chambers. In particular, OLED material layers may suffer from exposure to ambient air and/or oxygen and moisture. Accordingly, the manufacturing system 700, for example as shown in FIG. 7, can encapsulate the thin films before unloading the processed substrate via the exit load lock chamber 720.

According to yet further embodiments, the manufacturing system can include a carrier buffer 748. For example, the carrier buffer 748 can be connected to the first transfer chamber 712A, which is connected to the vacuum swing module 708 and/or the last transfer chamber, i.e. the sixth transfer chamber 712F. For example, the carrier buffer 748 can be connected to one of the transfer chambers, which is connected to one of the vacuum swing modules. Since the substrates are loaded and unloaded in the vacuum swing modules, it is beneficial if the carrier buffer 748 is provided close to a vacuum swing module. The carrier buffer 748 is configured to provide the storage for one or more, for example 5 to 30, carriers. The carriers in the buffer can be used during operation of the manufacturing system 700 in the event another carrier needs to be replaced, for example for maintenance, such as cleaning.

According to yet further embodiments, the manufacturing system can further include a mask shelf 750, i.e. a mask buffer. The mask shelf 750 is configured to provide storage for replacement patterned masks and/or masks, which need to be stored for specific deposition steps. According to methods of operating a manufacturing system 700, a mask can be transferred from the mask shelf 750 to a deposition apparatus 714 via the dual track transportation arrangement having the first track 734 and the second track 736. Thus, a mask in a deposition apparatus can be exchanged either for maintenance, such as cleaning, or for a variation of a deposition pattern without venting a deposition chamber 724, without venting a transfer chamber 712A-712F, and/or without exposing the mask to atmospheric conditions.

FIG. 7 further shows a mask cleaning chamber 752. The mask cleaning chamber 752 is connected to the mask shelf 750 via gate valve 726. Accordingly, a vacuum tight sealing can be provided between the mask shelf 750 and the mask cleaning chamber 752 for cleaning of a mask. According to different embodiments, the mask can be cleaned within the manufacturing system 700 by a cleaning tool, such as a plasma cleaning tool. A plasma cleaning tool can be provided in the mask cleaning chamber 752. Additionally or alternatively, another gate valve 754 can be provided at the mask cleaning chamber 752, as shown in FIG. 7. Accordingly, a mask can be unloaded from the manufacturing system 700 while only the mask cleaning chamber 752 needs to be vented. By unloading the mask from the manufacturing system, an external mask cleaning can be provided while the manufacturing system continues to be fully operating. FIG. 7 illustrates the mask cleaning chamber 752 adjacent to the mask shelf 750. A corresponding or similar cleaning chamber (not shown) may also be provided adjacent to the carrier buffer 748. By providing a cleaning chamber adjacent to the carrier buffer 748, the carrier may be cleaned within the manufacturing system 700 or can be unloaded from the manufacturing system through the gate valve connected to the cleaning chamber.

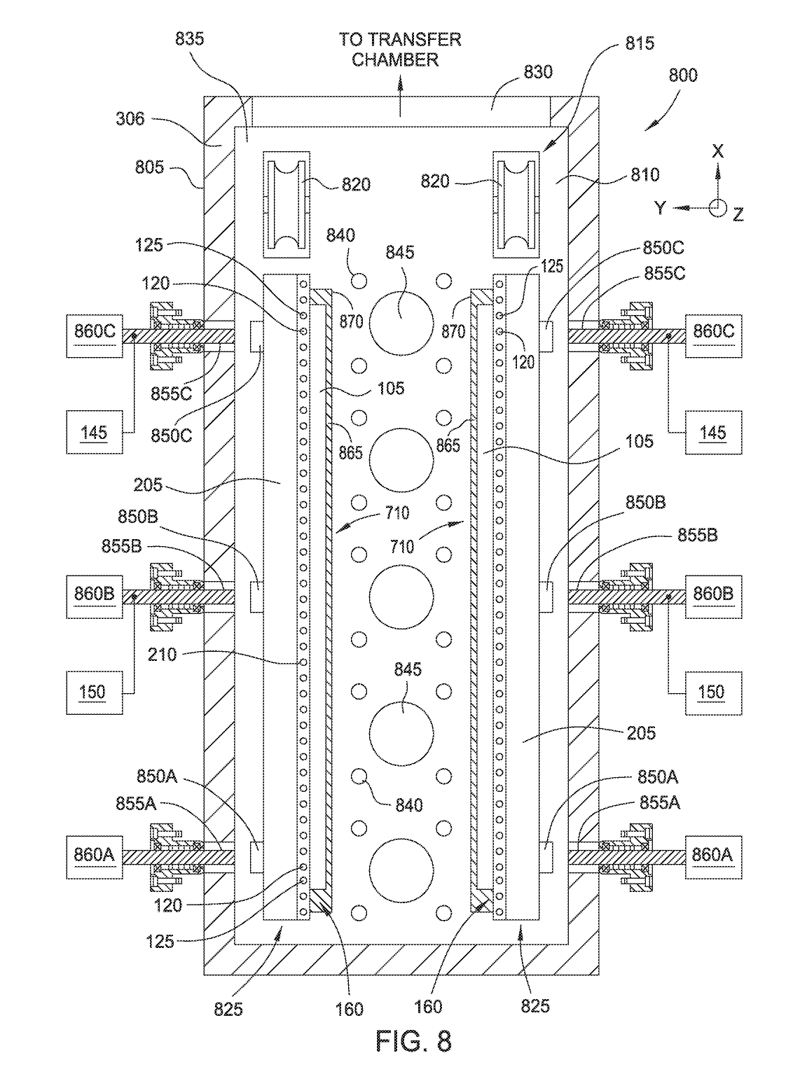

FIG. 8 is a top cross-sectional view of one embodiment of a deposition chamber 800. The deposition chamber 800 may be one of the deposition chambers 724 shown in FIG. 7. The deposition chamber 800 includes a chamber body 805 having a bottom 810 in which a drive system 815 moves a substrate carrier 710 (two carriers 710 are shown in an opposing relationship). Each carrier 710 includes an electrostatic chuck 825 that may be similar to the electrostatic chucks 100, 500 and 600 as described herein. The drive system 815 includes two or more rollers 820 (other rollers are hidden by the carriers 710) for moving the carriers 710. The chamber body 805 includes a sealable valve passage 830 through which the carriers 710 can be transferred between a transfer chamber (similar to the transfer chambers 712A-712F of FIG. 7) and the deposition chamber 800.

The chamber body 805 encloses an internal volume 835 having a plurality of gas sources 840 and plasma generators 845 disposed therein. The gas sources 840 are coupled to a gas panel (not shown) for providing processing gases to the internal volume 835. Examples of processing gases include gases suitable for the deposition of a film on the substrate such as silicon oxide, silicon nitride, amorphous silicon and micro-crystalline silicon. The plasma generators 845 may be a microwave source or other device suitable for energizing the processing gases within the internal volume 835 such that a plasma may be sustained. In one embodiment, the gas sources 840 are disposed between the plasma generators 845 and substrates 105 retained on the carriers 710. Pressure in the internal volume 835 may be maintained at about 1 Torr to about 10 Torr.

Connection between the cooling/heating reservoirs 145, the voltage supplies 150 and the carriers 710 may be made in any suitable manner. For example, using plug and socket connectors, blade connectors, screw terminals, quick disconnects, banana connectors and the like. In one embodiment, the carriers 710 include connectors 850A, 850B, 850C which releasably interconnect with mating connectors 855A, 855B, and 855C to respectively couple each of the cooling/heating reservoir 145 and the voltage supply 150 with the carriers 710. The mating connectors 855A, 855B, 855C may be coupled to actuators 860A, 860B, 860C which move the mating connectors 855A, 855B, 855C between a first position connected with the connectors 850A, 850B, 850C and a second position disconnected and clear from the connectors 850A, 850B, 850C. Movement from the first position to the second position facilitates movement of the carriers 710.

The substrates 105 may be securely chucked on the carriers 710 by energizing the voltage supplies 150. The carriers 710 provide the electrostatic fluid seal 160 about a perimeter of the substrates 105. The gas sources 840 and the plasma generators 845 may be utilized to form a film on the substrates 105 at select locations utilizing shadow masks 865. The shadow masks 865 are disposed between the substrates 105, the gas sources 840 and the plasma generators 845. The shadow masks 865 include a frame 870 that may be electrostatically coupled to the carriers 710, in one embodiment. The temperature of the substrates 105 may be controlled using the cooling/heating reservoirs 145. A coolant may be flowed through grooves or channels (not shown) formed in or on the carriers 710.

After processing, the cooling/heating reservoirs 145 and the voltage supplies 150 may then be disconnected from the carriers 710 to allow transfer of the respective substrates 105 on the carriers 710. The substrates 105 will remain electrostatically chucked to the carriers 710 for further processing in other processing chambers.

The electrostatic chucks 100, 500, 600 and 825 as described herein provide an electrostatic fluid seal 160 that effectively seals a perimeter of a substrate chucked thereon. A cooling gas may be flowed to cool the substrate chucked thereon and temperature of the substrate may be controlled. The electrodes 120 and 125 run parallel to the perimeter of the substrate which may minimize gaps and/or maintain flatness of the substrate. The minimization of gaps between the substrate and the electrostatic chucks 100, 500, 600 and 825 provides a low leak rate. The minimization of gaps between the substrate and the electrostatic chucks 100, 500, 600 and 825 may also provide good conduction of heat from the backside gas impinging the substrate.

While the foregoing is directed to embodiments of the present disclosure, other and further embodiments of the disclosure may be devised without departing from the basic scope thereof, and the scope thereof is determined by the claims that follow.

What is claimed is:

1. An electrostatic chuck, comprising:
a backing substrate; and
a puck substrate disposed on the backing substrate, the puck substrate comprising:
a plurality of central chucking modules surrounded by a perimeter chucking module, the perimeter chucking module having a first electrode and a second electrode that are parallel to each other and substantially parallel to sides of the puck substrate.

2. The chuck of claim 1, wherein the puck substrate includes a plurality of grooves for flowing a gas therethrough.

3. The chuck of claim 2, wherein the grooves are parallel to sides of the puck substrate.

4. The chuck of claim 2, wherein the plurality of grooves include a perimeter gas groove that is parallel to sides of the puck substrate.

5. The chuck of claim 4, wherein the perimeter gas groove is positioned inward of the first electrode and the second electrode.

6. The chuck of claim 1, wherein the perimeter chucking module comprises a chucking surface that is disposed in a plane that is the same as a plane of a chucking surface of the plurality of central chucking modules.

7. The chuck of claim 1, wherein the perimeter chucking module comprises a chucking surface that is disposed in a plane that is different than a plane of a chucking surface of the plurality of central chucking modules.

8. The chuck of claim 1, wherein the perimeter chucking module comprises a chucking surface that is tapered.

9. A substrate carrier, comprising:
an electrostatic chuck, comprising:
a backing substrate made of a metallic material; and
a puck substrate that is disposed on the backing substrate, the puck substrate comprising:
a plurality of central chucking modules surrounded by a perimeter chucking module, the perimeter chucking module having a first electrode and a second electrode that are parallel to each other and substantially parallel to sides of the puck substrate.

10. The carrier of claim 9, wherein the perimeter chucking module comprises an electrostatic fluid seal between the puck substrate and a substrate chucked thereon when the first and second electrodes are biased.

11. The carrier of claim 9, wherein the perimeter chucking module comprises a chucking surface that is disposed in a plane that is the same as a plane of a chucking surface of the plurality of central chucking modules.

12. The carrier of claim 9, wherein the perimeter chucking module comprises a chucking surface that is disposed in a plane that is different than a plane of a chucking surface of the plurality of central chucking modules.

13. The carrier of claim 9, wherein the perimeter chucking module comprises a chucking surface that is tapered.

14. The carrier of claim 9, wherein the puck substrate includes a plurality of grooves for flowing a gas therethrough.

15. The carrier of claim 14, wherein the grooves are parallel to sides of the puck substrate.

16. The carrier of claim 14, wherein the plurality of grooves include a perimeter gas groove that is parallel to sides of the puck substrate.

17. The carrier of claim 16, wherein the perimeter gas groove is positioned inward of the first electrode and the second electrode.

18. A method for chucking a display substrate, comprising:
providing an electrostatic chuck having a puck substrate with a chucking surface;
placing the display substrate onto the chucking surface; and
forming an electrostatic fluid seal at a perimeter of the display substrate by biasing a first electrode and a second electrode that are parallel to each other and substantially parallel to sides of the puck substrate.

19. The method of claim 18, further comprising:
flowing a gas that impinges a backside of the display substrate through grooves formed in the puck substrate.

20. The method of claim 18, wherein the electrostatic chuck comprises a substrate carrier for holding and transferring the display substrate through a deposition system.
